(19) United States
(12) Patent Application Publication
(10) Pub. No.: US 2023/0201843 A1
(43) Pub. Date: Jun. 29, 2023

(54) CENTRIFUGE DEVICE

(71) Applicant: Sangtech Lab Inc., Taipei (TW)

(72) Inventor: Cheng-Sheng Liang, Taipei (TW)

(73) Assignee: Sangtech Lab Inc., Taipei (TW)

(21) Appl. No.: 17/741,472

(22) Filed: May 11, 2022

(30) Foreign Application Priority Data
Dec. 29, 2021 (TW) 110149358

(51) Int. Cl. B04B 5/04

(52) U.S. Cl. CPC B04B 5/0407

(57) ABSTRACT

A centrifuge device includes a main body, a driving module, a centrifuge assembly, and a pipe. The main body has an accommodating space and a slot. The slot is connected to the accommodating space. The driving module is at least partially disposed in the accommodating space. The centrifuge assembly is disposed on the main body. A part of the centrifuge assembly is located in the accommodating space and connected to the driving module. The driving module is adapted to drive the centrifuge assembly to rotate. The pipe is connected to the part of the centrifuge assembly and extends out of the main body through the slot.

### CROSS-REFERENCE TO RELATED APPLICATION

This application claims the priority benefit of Taiwan application serial no. 110149358 filed on Dec. 29, 2021. The entirety of the above-mentioned patent application is hereby incorporated by reference herein and made a part of this specification.

### BACKGROUND

### Technical Field

The disclosure relates to a biochemical sample processing device, and more particularly to a centrifuge device.

### Description of Related Art

A conventional centrifuge device configured for biochemical detection and analysis has a relatively large volume because of containing a transmission mechanism and the need to consider the design of a closed loop system. In order to reduce the volume of the centrifuge device, a non-closed loop system is adopted in some designs. However, the non-closed loop system is susceptible to contamination, which in turn affects the test results of the substance under test. Therefore, it is difficult for a centrifuge device to have a small volume while maintaining an aseptic closed loop environment.

### SUMMARY

The disclosure provides a centrifuge device having a small volume while maintaining an aseptic closed loop environment.

A centrifuge device of the disclosure includes a main body, a driving module, a centrifuge assembly, and a pipe. The main body has an accommodating space and a slot, and the slot is connected to the accommodating space. The driving module is at least partially disposed in the accommodating space. The centrifuge assembly is disposed on the main body. A part of the centrifuge assembly is located in the accommodating space and connected to the driving module, which is adapted to drive the centrifuge assembly to rotate. The pipe is connected to the part of the centrifuge assembly and extends out of the main body through the slot.

In an embodiment of the disclosure, the driving module includes a driving source and a linkage assembly. The linkage assembly is located in the accommodating space and coupled between the driving source and the part of the centrifuge assembly.

In an embodiment of the disclosure, the linkage assembly includes a base gear, a speed increasing gear set, and a driven gear. The speed increasing gear set is connected to the driving source. The driven gear is connected to the centrifuge assembly. The speed increasing gear set is coupled between the base gear and the driven gear.

In an embodiment of the disclosure, the angular velocity of the driven gear around a rotation axis direction of the centrifuge assembly is twice the angular velocity of the speed increasing gear set around the rotation axis direction.

In an embodiment of the disclosure, the centrifuge assembly includes a tube and a centrifuge bowl. The part of the centrifuge assembly is one end of the tube, and the other end of the tube is connected to the centrifuge bowl. The pipe is connected to the centrifuge bowl through guidance of the tube.

In an embodiment of the disclosure, the centrifuge assembly includes a centrifuge bowl, which has a centrifuge space, a connecting end, and multiple channels. The multiple channels are connected between the centrifuge space and the connecting end. The pipe is connected to the connecting end and has multiple flow channels. The multiple flow channels correspond to the multiple channels, respectively.

In an embodiment of the disclosure, open ends of the multiple channels in the centrifuge space are arranged along the radial direction of the centrifuge assembly.

In an embodiment of the disclosure, the centrifuge assembly includes a seat body, having at least one positioning hole, and the main body has at least one positioning post. The at least one positioning post is adapted to pass through the at least one positioning hole along a direction parallel to a rotation axis direction of the centrifuge assembly. The seat body is adapted to rotate with the rotation axis direction as the rotation axis so that the at least one positioning post is positioned at the at least one positioning hole.

In an embodiment of the disclosure, the at least one positioning hole has a first section and a second section, and the aperture of the first section is larger than the aperture of the second section. The at least one positioning post includes a stop element and a connection element, and the connection element is connected between the stop element and the main body. The outer diameter of the stop element is larger than the aperture of the second section, and the stop element is adapted to pass through at least one positioning hole in the first section along a direction parallel to the rotation axis direction. The seat body is adapted to rotate with the rotation axis direction as the rotation axis, so that the at least one positioning post corresponds to the second section.

In an embodiment of the disclosure, the at least one positioning hole has a first section and a second section, and the aperture of the first section is larger than the aperture of the second section. At least one positioning post is contractibly connected to the main body and includes a locking element and a releasing element. Moreover, the locking element is connected between the releasing element and the main body. The outer diameter of the locking element is larger than the aperture of the second section, and the outer diameter of the releasing element is smaller than the aperture of the second section. The releasing element is adapted to extend into at least one positioning hole in a direction parallel to the rotation axis direction in the second section. The seat body is adapted to rotate around the rotation axis direction as the rotation axis so that at least one positioning post corresponds to the first section, and the locking element is adapted to extend into at least one positioning hole in a direction parallel to the rotation axis in the first section.

Based on the above, in the centrifuge device of the disclosure, the driving module is at least partially disposed in the accommodating space of the main body, and the pipe is connected to the centrifuge assembly in the accommodating space and extends to the outside of the accommodating space through the slot of the main body. With such a configuration, a part of the driving module and a part of the pipe are contained in the centrifuge device without excessively increasing the volume of the overall structure outside the centrifugal device. Since the volume of the centrifuge device is reduced as described above, there is no need to adopt a non-closed design for the pipe in order to reduce the volume of the device. Therefore, the centrifuge device of the disclosure has a reduced volume while coping with the needs for an aseptic closed loop.

### BRIEF DESCRIPTION OF THE DRAWINGS

FIG. 1 is a perspective view of a centrifuge device according to an embodiment of the disclosure.

FIG. 2 is a cross-sectional view of the centrifuge device of FIG. 1.

FIG. 3 is a partial cross-sectional view of the centrifuge assembly of FIG. 1.

FIG. 4 is a partial cross-sectional view of the pipe of FIG. 1.

FIGS. 5A to 5C illustrate the installation process of the centrifuge assembly of FIG. 1.

### DESCRIPTION OF THE EMBODIMENTS

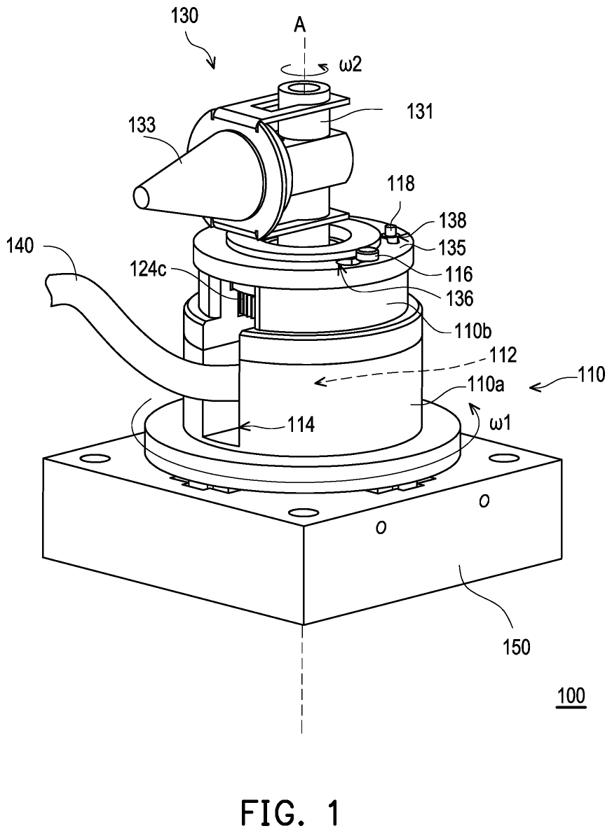

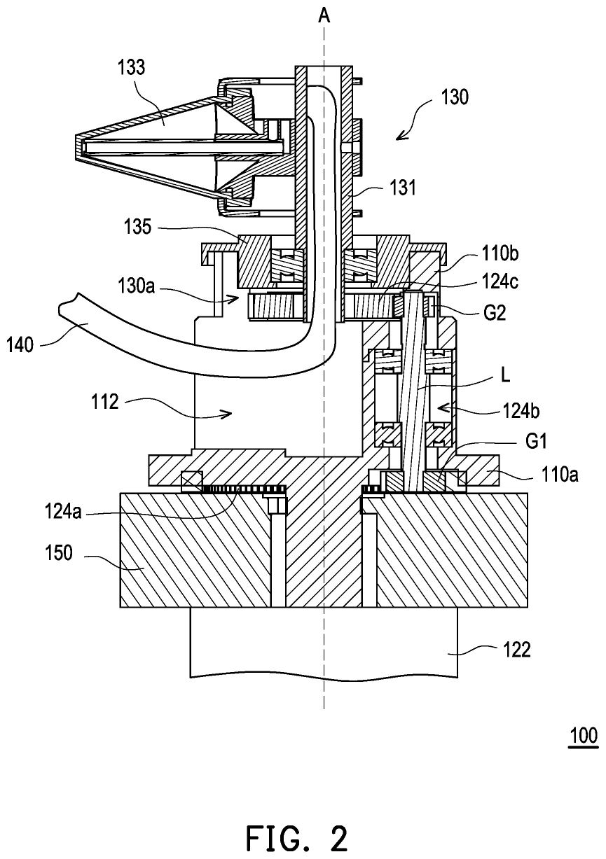

FIG. 1 is a perspective view of a centrifuge device according to an embodiment of the disclosure. FIG. 2 is a cross-sectional view of the centrifuge device of FIG. 1. Referring to FIGS. 1 and 2, a centrifuge device 100 of the embodiment includes a main body 110, a driving module 120, a centrifuge assembly 130, and a pipe 140. The main body 110 has an accommodating space 112 and a slot 114, and the slot 114 is connected to the accommodating space 112. The driving module 120 is at least partially disposed in the accommodating space 112. The centrifuge assembly 130 is disposed on the main body 110, and a part 130a of the centrifuge assembly 130 is located in the accommodating space 112 and connected to the driving module 120. Moreover, the driving module 120 is adapted for driving the centrifuge assembly 130 to rotate. The pipe 140 is connected to the part 130a of the centrifuge assembly 130 and extends out of the main body 110 through the slot 114.

With such a configuration, a part of the driving module 120 and a part of the pipe 140 are contained in the centrifuge device 100 without excessively increasing the volume of the overall structure outside the centrifuge device 100. Since the volume of the centrifuge device 100 is reduced as described above, there is no need to adopt a non-closed design for the pipe 140 in order to reduce the volume of the device. Therefore, the centrifuge device 100 of the disclosure has a reduced volume while coping with the needs for an aseptic closed loop.

The structure and the connection relationship of the main body 110, the driving module 120, and the centrifuge assembly 130 are further described as follows.

In the embodiment, the centrifuge device 100 further includes a base 150. The main body 110 includes a housing 110a and a cover 110b on the other side with respect to the housing 110a. The housing 110a is disposed on the base 150, and the centrifuge assembly 130 is disposed on the cover 110b. Moreover, the part 130a of the centrifuge assembly 130 is located in the cover 110b. In other words, the centrifuge device 100 is disposed in the order of the centrifuge assembly 130, the main body 110, and the base 150 from top to bottom.

In detail, the driving module 120 includes a driving source 122 and a linkage assembly 124. The driving source 122 is, for example, a motor, and the linkage assembly 124 is located in the accommodating space 112 and coupled between the driving source 122 and the part 130a of the centrifuge assembly 130, as shown in FIG. 2. The driving source 122 is configured on the base 150 to drive the linkage assembly 124, and the linkage assembly 124 in turn drives the centrifuge assembly 130.

Furthermore, the linkage assembly 124 includes a base gear 124a, a speed increasing gear set 124b, and a driven gear 124c. The base gear 124a is fixed on the upper surface of the base 150. The driven gear 124c is connected to the centrifuge assembly 130 and located in the cover 110b. The speed increasing gear set 124b is connected to the driving source 122 and the main body 110, and is coupled between the base gear 124a and the driven gear 124c. Moreover, the speed increasing gear set 124b revolves around a rotation axis direction A along the base gear 124a with the rotation axis direction A as the center, and the driven gear 124c rotates with the rotation axis direction A as the rotation axis. In other words, the linkage assembly 124 sequentially transmits the power of the driving source 122 to the main body 110 and the centrifuge assembly 130 in the order of the speed increasing gear set 124b and the driven gear 124c so that the main body 110 and the centrifuge assembly 130 coaxially rotate with the rotation axis direction A as the rotation axis.

In addition, the speed increasing gear set 124b is disposed to deviate from the rotation axis direction A, and is located closer to a side of the main body 110 in the accommodating space 112. The slot 114 is disposed on the other side of the main body 110 with respect to the speed increasing gear set 124b. In this way, the accommodating space 112 has enough space inside to allow the pipe 140 to be connected to the part 130a of the centrifuge assembly 130, and the pipe 140 may extend out of the main body 110 through the slot 114.

In the embodiment, when the centrifuge assembly 130 performs a centrifugal action and rotates, the pipe 140 connected to the centrifuge assembly 130 rotates with the centrifuge assembly 130. The other end of the pipe 140 is connected to a fixed end, and the liquid flowing in or out of the pipe 140 may be controlled by a pump and a passage opening and closing apparatus. However, the disclosure is not limited thereto. It should be noted that, since one end of the pipe 140 is a fixed end and the other end is a movable end, the pipe 140 may be twisted and damaged. Therefore, in addition to driving the centrifuge assembly 130 to rotate, the driving module 120 of the centrifuge device 100 of the embodiment also drives the main body 110 to coaxially rotate with the centrifuge assembly 130 on a rotation axis direction A. Moreover, the angular velocity of the centrifuge assembly 130 is twice the angular velocity of the main body 110. Therefore, the pipe 140 may be prevented from being damaged by twisting. For the detailed anti-torsion mechanism, reference is directed to the prior art document 1 (New Flow-Through Centrifuge Without Rotating Seals Applied to Plasmapheresis. Therapeutic Apheresis, p95—p97, Vol. 4, No. 2, 2000, Blackwell Science, Inc), and thus further descriptions are not repeated here. However, the design of the angular velocity difference is further described as follows.

In the embodiment, the speed increasing gear set 124b includes a gear G1, a gear G2, and a connecting rod L. The gear G1 is coupled to the base gear 124a, the gear G2 is coupled to the driven gear 124c, and the connecting rod L is connected between the gear G1 and the gear G2. The speed increasing gear set 124b and the main body 110 driven by the speed increasing gear set 124b have an initial angular velocity col around the rotation axis direction A of the centrifuge assembly 130. The centrifuge assembly 130 at the end of power transmission has an angular velocity ω2 around the rotation axis direction A of the centrifuge assembly 130 (i.e., the angular velocity of the driven gear 124c around its own center plus the angular velocity ω1). Assuming that the number of teeth of the base gear 124a is N1, the number of teeth of the gear G1 is N2, the number of teeth of the gear G2 is N3, and the number of teeth of the driven gear 124c is N4, the following formula may be derived based on the relationship between the number of teeth and the angular velocity:

ω2/ω1=(N1/N2)×(N3/N4)+1

In the embodiment, through the design of different gear ratios, and with the speed change by the speed increasing gear set 124b, the angular velocity ω2 of the centrifuge assembly 130 is higher than the angular velocity ω1 of the main body 110. For example, the angular velocity ω2 is twice the angular velocity ω1. Therefore, the effect of preventing the twisting of the pipe 140 mentioned in the prior art document 1 may be achieved. Certainly, the disclosure does not limit the number of teeth of the gear as long as the angular velocity ω2 is twice the angular velocity ω1.

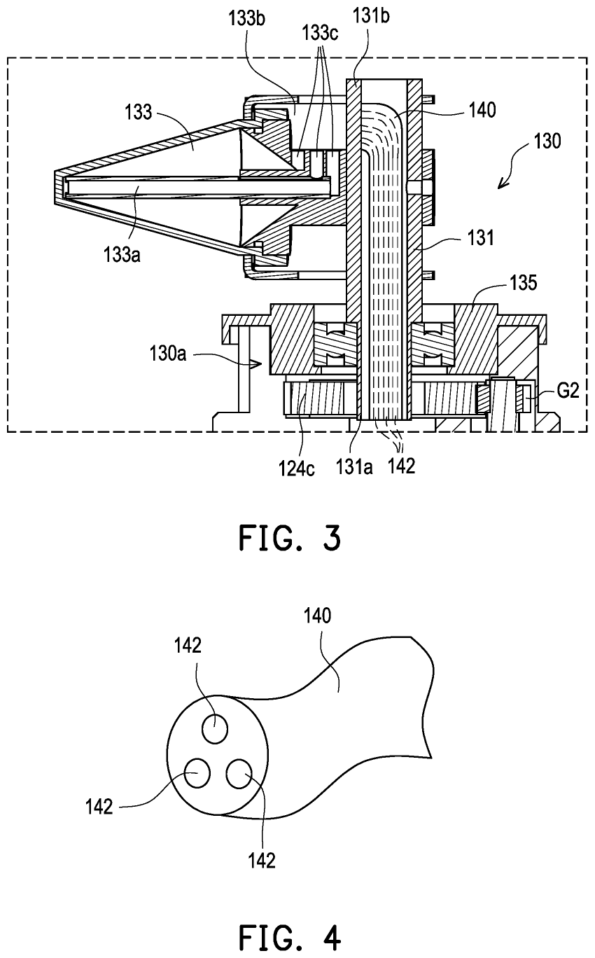

FIG. 3 is a partial cross-sectional view of the centrifuge assembly of FIG. 1. FIG. 4 is a partial cross-sectional view of the pipe of FIG. 1. Referring to FIGS. 3 and 4, in the embodiment, the centrifuge assembly 130 includes a tube 131 and a centrifuge bowl 133. The part 130a of the centrifuge assembly 130 is an end 131a of the tube 131, the other end 131b of the tube 131 is connected to the centrifuge bowl 133, and the pipe 140 is connected to the centrifuge bowl 133 through guidance of the tube 131. Since the end 131a of the tube 131 is connected to the driven gear 124c, the tube 131 and the centrifuge bowl 133 are driven by the driving module 120 to rotate, thereby causing the detection liquid in the centrifuge bowl 133 to perform centrifugal movement and be stratified.

In detail, the centrifuge bowl 133 has a centrifuge space 133a, a connecting end 133b, and multiple channels 133c. The multiple channels 133c are connected between the centrifuge space 133a and the connecting end 133b. The pipe 140 is connected to the connecting end 133b and has multiple flow channels 142, and the multiple flow channels 142 correspond to the multiple channels 133c, respectively. In the embodiment, the number of channels 133c and flow channels 142 is, for example, three, and one of the three is responsible for the input of liquid, and the other two are responsible for pumping out the stratified liquid after centrifugation. However, the disclosure is not limited thereto.

The open ends of the multiple channels 133c in the centrifuge space 133a (the side close to the tube 131) are arranged along the radial direction of the centrifuge assembly 130. Therefore, the liquid may flow in or out of the multiple channels 133c from the multiple flow channels 142, enter or leave the centrifuge space 133a, and correspondingly transport the stratified liquid after centrifugation.

In addition, in an embodiment, a sensor may be provided in combination with the centrifuge device 100 to control the inflow and outflow of liquid. The sensor may be, for example, an optical sensor, which may detect the working condition of the centrifuge assembly 130, such as the condition that the centrifuge space 133a is filled with liquid, whether the centrifugation is completed or not, and so on. The optical sensor is connected to the centrifuge assembly 130 and electrically connected to a pump, and may control the pump to pump in or out the liquid in the pipe 140 according to a detected result to ensure that the centrifuged liquid in the centrifuge assembly 130 is maintained at a certain amount or to pump out the liquid after centrifugation.

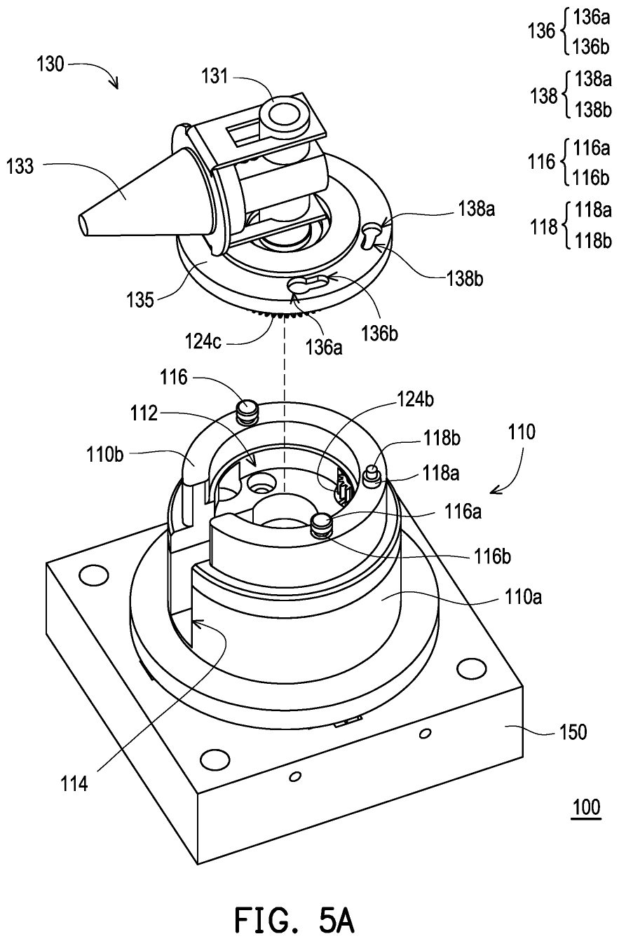

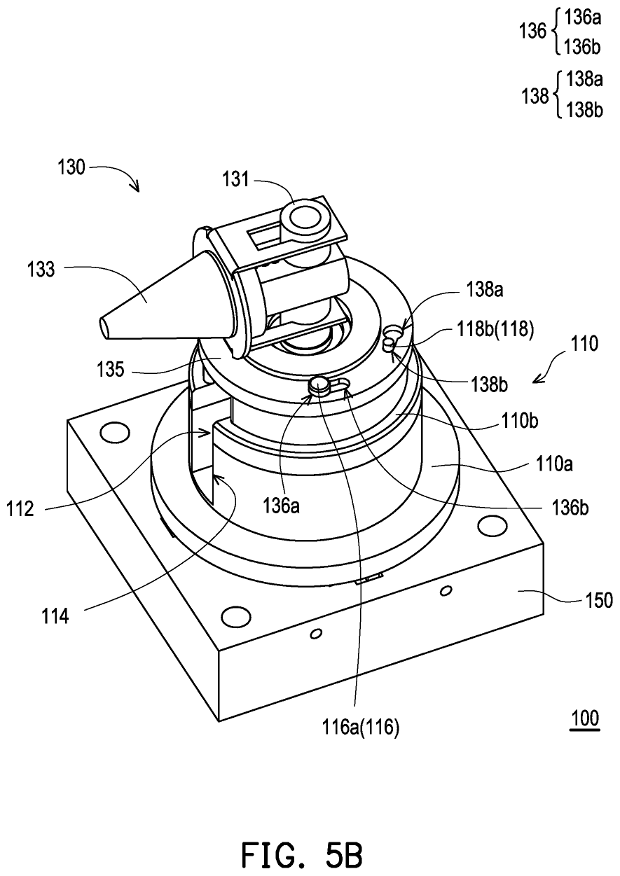

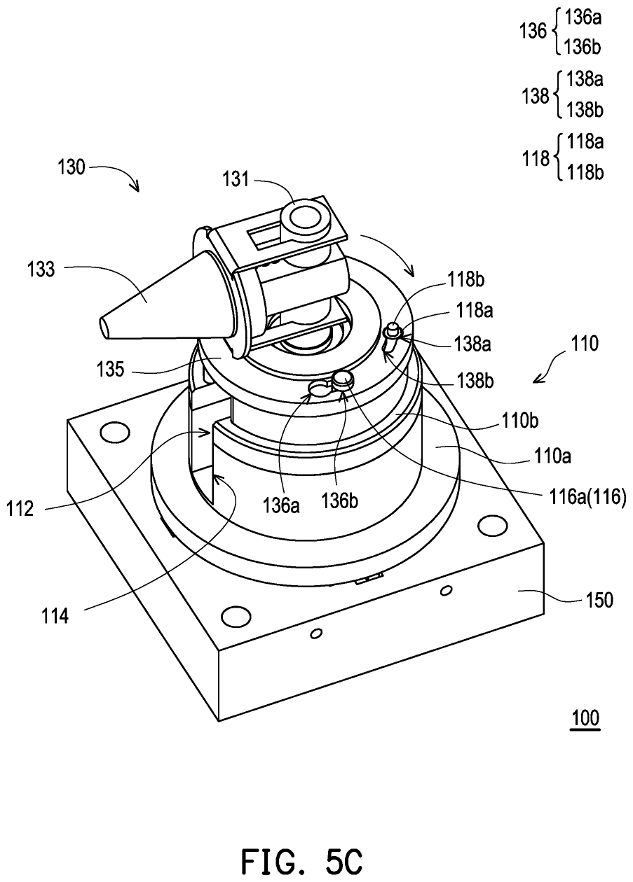

FIGS. 5A to 5C illustrate the installation process of the centrifuge assembly of FIG. 1. Referring to FIGS. 5A to 5C, in order to facilitate the description of the installation process, the pipe 140 is omitted from the drawings. In the embodiment, the centrifuge assembly 130 includes a seat body 135 so that the centrifuge assembly 130 is detachably disposed on the main body 110. The seat body 135 has at least one positioning hole 136, and the main body 110 has at least one positioning post 116. The positioning post 116 is adapted to pass through the positioning hole 136 along a direction parallel to the rotation axis direction A of the centrifuge assembly 130. The seat body 135 is adapted to rotate with the rotation axis direction A as the rotation axis so that the positioning post 116 is positioned in the positioning hole 136.

In detail, the positioning hole 136 has a first section 136a and a second section 136b, and the aperture of the first section 136a is larger than the aperture of the second section 136b. The positioning post 116 includes a stop element 116a and a connection element 116b, and the connection element 116b is connected between the stop element 116a and the main body 110. The outer diameter of the stop element 116a is larger than the aperture of the second section 136b and slightly smaller than the aperture of the first section 136a. Moreover, the outer diameter of the connection element 116b is smaller than the second section 136b. Therefore, the stop element 116a is adapted to pass through the positioning hole 136 along the direction parallel to the rotation axis direction A in the first section 136a, and the connection element 116b is adapted to slide in the second section 136b. The seat body 135 is adapted to rotate with the rotation axis direction A as the rotation axis so that the positioning post 116 corresponds to the second section 136b, as shown in FIGS. 5A to 5C. Thus, the step of installing the centrifuge assembly 130 on the main body 110 is completed.

In addition, in the embodiment, the seat body 135 further has a positioning hole 138, and the main body 110 further has a positioning post 118. The positioning hole 138 has a first section 138a and a second section 138b, and the aperture of the first section 138a is larger than the aperture of the second section 138b. The positioning post 118 is contractibly connected to the main body 110 and includes a locking element 118a and a releasing element 118b. The locking element 118a is connected between the releasing element 118b and the main body 110. The outer diameter of the locking element 118a is larger than the aperture of the second section 138b and slightly smaller than the aperture of the first section 138a. Moreover, the outer diameter of the releasing element 118b is smaller than the aperture of the second section 138b.

Further to the above, the releasing element 118b is adapted to extend into the positioning hole 138 along a direction parallel to the rotation axis direction A in the second section 138b. Moreover, the seat body 135 is pushed against the locking element 118a so that the positioning post 118 is compressed along the direction parallel to the rotation axis direction A. The seat body 135 is adapted to rotate with the rotation axis direction A as the rotation axis so that the positioning post 118 corresponds to the first section 138a. At this time, the locking element 118a is no longer pushed by the seat body 135 and releases the elastic potential energy so that the locking element 118a is adapted to extend into the positioning hole 138 along the direction parallel to the rotation axis direction A in the first section 138a, as shown in FIGS. 5A to 5C. Thus, the step of installing the centrifuge assembly 130 on the main body 110 is completed.

When a user wants to disassemble the centrifuge assembly 130, the disassembly may be completed by the reverse of the installation step. Specifically, the user presses the positioning post 118 with an index finger so that the positioning post 118 is compressed in the direction parallel to the rotation axis direction A, and the locking element 118a passes through the first section 138a. Next, the user clamps the seat body 135 with a thumb and a middle finger, and rotates, with the rotation axis direction A as the rotation axis, in the direction opposite to the direction during the installation so that the positioning post 116 corresponds to the first section 136a, and the positioning post 118 corresponds to the second section 138b. The user then extracts the centrifuge assembly 130 in the direction parallel to the rotation axis direction A so that the stop element 116a passes through the first section 136a, and the releasing element 118b passes through the second section 138b, as shown in FIGS. 5C to 5A. Thus, the step of disassembling the centrifuge assembly 130 from the main body 110 is completed.

In summary, in the centrifuge device of the disclosure, the driving module is at least partially disposed in the accommodating space of the main body, and the pipe is connected to the centrifuge assembly in the accommodating space and extends to the outside of the accommodating space through the slot of the main body. With such a configuration, a part of the driving module and a part of the pipe are contained in the centrifuge device without excessively increasing the volume of the overall structure outside the centrifugal device. Since the volume of the centrifuge device is reduced as described above, there is no need to adopt a non-closed design for the pipe in order to reduce the volume of the device. Therefore, the centrifuge device of the disclosure has a reduced volume while coping with the needs for an aseptic closed loop.

In addition, in the centrifuge device of the disclosure, the seat body of the centrifuge assembly has at least one positioning hole, and the main body has at least one positioning post. Accordingly, the centrifuge assembly can be easily installed on the main body. When disassembling the centrifuge assembly, the user may also easily disassemble the centrifuge assembly with one hand. Moreover, when the centrifuge assembly needs to be replaced or cleaned as a consumable, the user can easily replace or disassemble the centrifuge assembly, thereby reducing installation man-hours and costs.

What is claimed is:

1. A centrifuge device, comprising:
a main body having an accommodating space and a slot, wherein the slot is connected with the accommodating space;
a driving module at least partially disposed in the accommodating space;
a centrifuge assembly disposed on the main body, wherein a part of the centrifuge assembly is located in the accommodating space and connected to the driving module, and the driving module is adapted to drive the centrifuge assembly to rotate; and
a pipe connected to the part of the centrifuge assembly and extending out of the main body through the slot.

2. The centrifuge device according to claim 1, wherein the driving module comprises a driving source and a linkage assembly, and the linkage assembly is located in the accommodating space and coupled between the driving source and the part of the centrifuge assembly.

3. The centrifuge device according to claim 2, wherein the linkage assembly comprises a base gear, a speed increasing gear set, and a driven gear, and the speed increasing gear set is connected to the driving source, the driven gear is connected to the centrifuge assembly, and the speed increasing gear set is coupled between the base gear and the driven gear.

4. The centrifuge device according to claim 3, wherein an angular velocity of the driven gear around a rotation axis direction of the centrifuge assembly is twice an angular velocity of the speed increasing gear set around the rotation axis direction.

5. The centrifuge device according to claim 1, wherein the centrifuge assembly comprises a tube and a centrifuge bowl, the part of the centrifuge assembly is an end of the tube, another end of the tube is connected to the centrifuge bowl, and the pipe is connected to the centrifuge bowl through guidance of the tube.

6. The centrifuge device according to claim 1, wherein the centrifuge assembly comprises a centrifuge bowl having a centrifuge space, a connecting end, and a plurality of channels, the plurality of channels are connected between the centrifuge space and the connecting end, the pipe is connected to the connecting end and has a plurality of flow channels, and the plurality of flow channels correspond to the plurality of channels, respectively.

7. The centrifuge device according to claim 6, wherein open ends of the plurality of channels in the centrifuge space are arranged along a radial direction of the centrifuge assembly.

8. The centrifuge device according to claim 1, wherein the centrifuge assembly comprises a seat body having at least one positioning hole, the main body has at least one positioning post adapted to pass through the at least one positioning hole along a direction parallel to a rotation axis direction of the centrifuge assembly, and the seat body is adapted to rotate with the rotation axis direction as a rotation axis so that the at least one positioning post is positioned in the at least one positioning hole.

9. The centrifuge device according to claim 8, wherein the at least one positioning hole has a first section and a second section, an aperture of the first section is larger than an aperture of the second section, the at least one positioning post comprises a stop element and a connection element connected between the stop element and the main body, an outer diameter of the stop element is larger than the aperture of the second section, the stop element is adapted to pass through the at least one positioning hole along a direction parallel to the rotation axis direction in the first section, and the seat body is adapted to rotate with the rotation axis direction as the rotation axis so that the at least one positioning post corresponds to the second section.

10. The centrifuge device according to claim 8, wherein the at least one positioning hole has a first section and a second section, an aperture of the first section is larger than an aperture of the second section, the at least one positioning post is contractibly connected to the main body and comprises a locking element and a releasing element, the locking element is connected between the releasing element and the main body, an outer diameter of the locking element is larger than the aperture of the second section, an outer diameter of the releasing element is smaller than the aperture of the second section, and the releasing element is adapted to extend into the at least one positioning hole along a direction parallel to the rotation axis direction in the second section, and the seat body is adapted to rotate with the rotation axis direction as the rotation axis so that the at least one positioning post corresponds to the first section, and the locking element is adapted to extend into the at least one positioning hole in the first section along a direction parallel to the rotation axis direction.
